(19) United States
(12) Patent Application Publication
(10) Pub. No.: US 2007/0200900 A1
(43) Pub. Date: Aug. 30, 2007

(54) Energy efficient thermal inkjet print head

(76) Inventor: Alex Kuo-Shen Wang, Las Vegas, NV (US)

Correspondence Address: PRO-TECHTOR INTERNATIONAL SERVICES, 20775 NORADA CT., SARATOGA, CA, 95070, US

(21) Appl. No.: 11/365,908

(22) Filed: Feb. 28, 2006

(51) Int. Cl. B41J 2/05

(52) U.S. Cl. 347/61

(57) ABSTRACT

A energy efficient thermal inkjet print head according to the present invention includes a plurality of the breathing nozzles configured around a main nozzle on a nozzle plate of an inkjet print head, the grouped resistors formed by the small resistors opposite the breathing nozzle building an insulation surrounding wall to enhance the spurting capability of a main heating resistor with forward kinetic energy and advantages such as ink and power saving, enhanced printing quality and efficiency and doubled speed of ink resupplying.

### BACKGROUND OF THE INVENTION

(a) Field of the Invention

The present invention relates to a energy efficient thermal inkjet print head comprising a plurality of grouped resistors around a main resistor. The aforesaid main resistor is an inkjet energy resource base, and the grouped resistors form the insulating walls enhancing the ink spurting capability of a main heating resistor by the forward kinetic energy.

(b) Description of the Prior Art

Laser printers and inkjet printers are the primary printers in the general market, and the printing technologies used in these two types of printers have their advantages and disadvantages. Presently, inkjet printing technology is the major printing technology used for color printing, and includes use of a thermal bubble inkjet print head that employs heating elements (such as: resistance heater elements) to momentarily direct high heat towards ink to produce bubbles, which are then sprayed out.

Referring to FIGS. 1 and 2, which show a schematic view of a conventional ink cartridge 1 and a cutaway view of the ink cartridge 1 along the tangent 2-2 of FIG. 1 respectively, wherein the ink cartridge 1 comprises a case 11, interior of which forms an ink storage tank 12 that is used to store ink A and an inkjet print head 2 disposed on the ink cartridge 1 and interconnecting with the ink storage tank 12. The inkjet print head 2 is used to control output of the ink A. A conventional inkjet print head chip 21 is disposed within the inkjet print head 2, and includes a manifold 22, which forms a channel between the inkjet print head 2 and the ink storage tank 12. The inkjet print head 2 further comprises a nozzle plate 23, and a plurality of ink chambers 24 are formed between the nozzle plate 23 and the chip 21.

The chip 21 comprises a plurality of heating resistors 211, each of which are used to heat the ink A stored within a corresponding ink chamber 24 to produce bubbles. The nozzle plate 23 comprises a plurality of nozzles 231, each of which corresponds to one of the heating resistors 211. When a current passes through the heating resistors 211, the ink A within the ink chambers 24 is heated, thereby producing bubbles, and the ink A is then able to be sprayed through the nozzles 231.

Because neither the satellite spurting holes are configured around a nozzle 231 of a conventional nozzle plate 23, nor the grouped resistors are configured around the ink spurting power base of a heating resistor 211 (also known as a main resistor). Therefore, insulating surrounding walls are not built around the heating resistor 211 enhancing ink spurting capability of the main resistor and lacking the function of power assistance. Providing stable inkjet printing quality by speeding up the heating of the resistors with high voltage causes disadvantages such as great loss of power, scattered ink drops, delayed spurting or multi-dropped spurting. Since the speed of the conventional low-speed inkjets cannot be enhanced, and the inkjet nozzle 2 are not effective in saving power, the cost of printing is higher while the printing quality is lower.

### SUMMARY OF THE INVENTION

The primary object of the invention is to provide a energy efficient thermal inkjet print head consisted of a main heating resistor with curve-shaped top as an inkjet energy resource base of ink spurting. A plurality of grouped resistors forms the insulating surrounding walls around the main heating resistor by group capillarity enhancing the spurting capabilities of the main heating resistor by forward kinetic energy. The supporting power provided thereby avoids scattered ink drops, delayed spurting, multi-dropped spurting to prevent wasting of ink. The pressure difference of main energy resource and supporting power thereof accelerates the ink resupplying process and the printing process; furthermore, effectively saves ink and power while lowering the cost of printing and provides satisfying printing quality.

To better understand the invention, detailed descriptions of a preferred embodiment shall be given with the accompanying drawings below.

### BRIEF DESCRIPTION OF THE DRAWINGS

FIG. 1 shows an elevational view of a conventional ink cartridge.

FIG. 2 shows a cutaway view of a conventional ink cartridge along the tangent 2-2 of FIG. 1.

FIG. 3 shows a partial sectional view of a energy efficient thermal inkjet print head according to the invention.

FIG. 4-1 shows a diagram of a main heating resistor before forming air bubbles.

FIG. 4-2 shows a diagram of a main heating resistor starting to form air bubbles.

FIG. 4-3 shows a diagram of a main heating resistor when air bubbles are formed.

FIG. 4-4 shows a diagram of a main heating resistor after air bubbles are formed.

FIG. 5 shows an elevational view of a black and white inkjet print head of an ink cartridge according to the invention.

FIG. 6 shows an elevational view of a color inkjet print head of an ink cartridge according to the invention.

FIG. 7 shows another elevational view of a color inkjet print of an ink cartridge according to the invention.

### DETAILED DESCRIPTION OF THE PREFERRED EMBODIMENTS

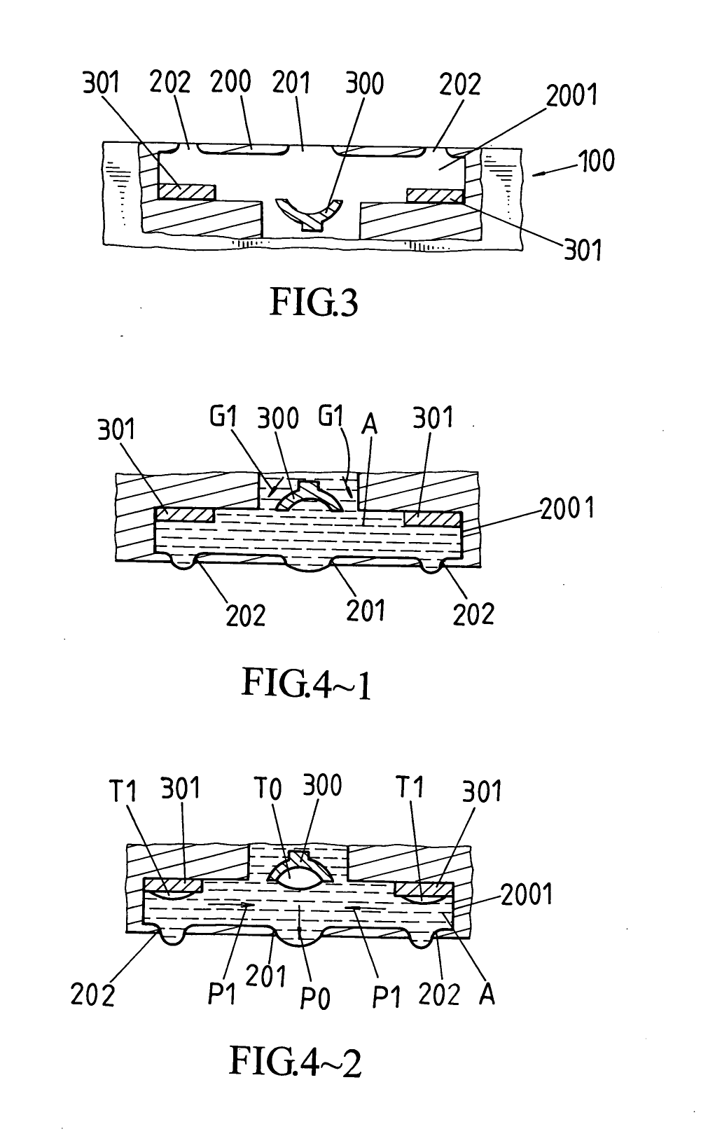

As shown in FIG. 3, an inkjet print head 100 according to the invention comprising a main nozzle 201 on a nozzle plate 200 with an ink chamber 2001 inside. A main heating resistor 300 with curved top heating up the ink to form air bubbles is configured opposite the main nozzle 201. When the air bubbles are formed, the ink is squeezed and spurted from the main nozzle 201 to print on papers. The invention is characterized in:

A plurality of breathing nozzles 202 is configured around the main nozzle 201 of the nozzle plate 200. A small resistor 301 is installed on each side of the breathing nozzle 202 to form the grouped resistors. The main heating resistor 300 with curved top is the ink spurting power base, and the small resistors 301 around form grouped resistors and build an insulating surrounding wall to increase spurting capabilities of the main heating resistor 300 with forward kinetic energy. The supporting power formed by the grouped resistors avoids disadvantage of ink wasting such as scattered ink drops and delayed spurting. The pressure difference formed by the main power of the main heating resistor 300 and the supporting power of the grouped resistors accelerates the ink refilling, and a physical change caused by the supporting power form air bubbles guiding and controlling the ink flow further while decreasing internal impedance. Based on the principle that the weight of the ink and the frequency of the ink spurting is an inverse ratio, the ink resupplying design that the power source leads the pressure speed solve the major disadvantage of a conventional inkjet printer.

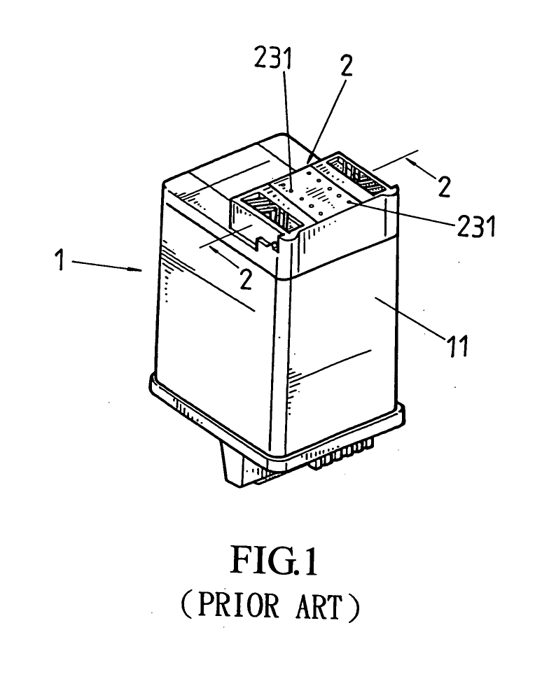

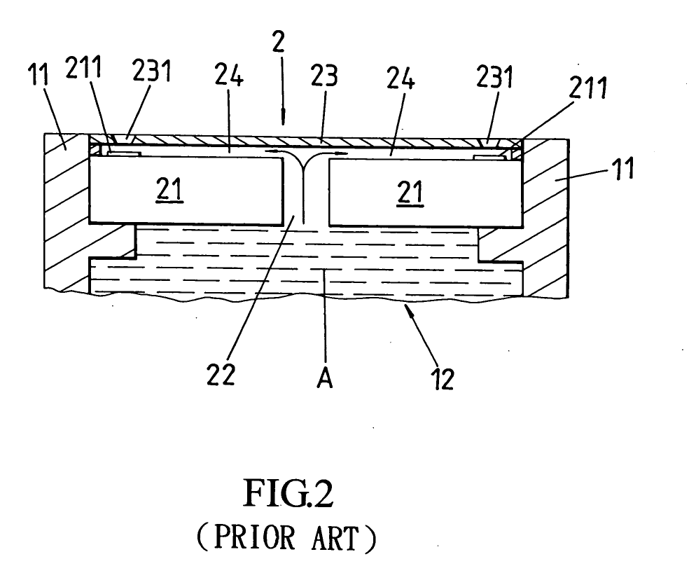

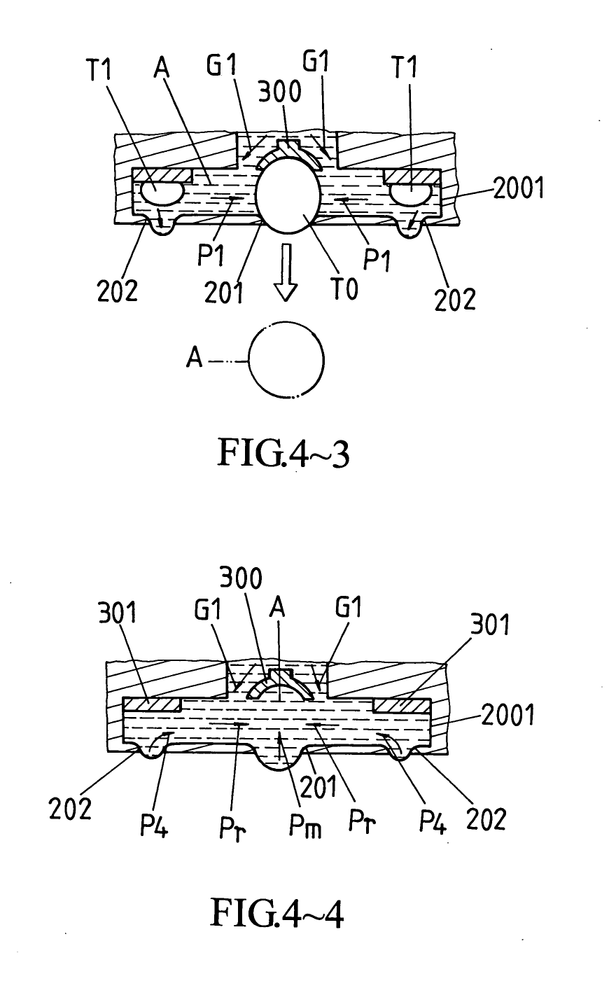

According to FIG. 4-1, FIG. 4-2, FIG. 4-3 and FIG. 4-4, a main nozzle 201 and a breathing nozzle 202 thereof are facing downward. FIG. 4-1 shows that the main nozzle 201 opposite a main heating resistor 300 and the breathing nozzle 202 opposite of a small resistor 301 have not formed air bubbles. Wherein, the surface tension of the base of the ink A remains balanced inside of an ink chamber 2001.

In FIG. 4-2, when the main heating resistor 300 and a plurality of small resistor 301 are being heated, a large air bubble T0 of the main heating resistor 300 and a small air bubble T1 of the small resistor 301 start to form and push the ink A inside of the ink chamber 2001 downward to the main nozzle 201 and the breathing nozzle 202. The pressure from the main nozzle including a main power source P0 and the supporting power source P1 around. The total pressure thereof equals to the sum of P0 and nP1, which is also the pressure of the main power source and the surrounding supporting power source.

Referring to FIG. 4-3, when air bubbles T0 and T1 of the main heating resistor 300 and a plurality of small resistor 301 form, the ink A is spurted from the main nozzle 201 to the paper. The surface tension of the ink A remains at the breathing nozzle 201 to avoid various bad printing qualities such as small dotted ink spurting and delayed spurting to save the ink A and operating power.

As shown in FIG. 4-4, after the main nozzle 201 finishes printing, the large air bubble T0 and the small air bubble T1 disappear, supporting power source P4 returns to be below the heating resistor 300 from the breathing nozzle 202 assisting the pressure Pr and Pm to recover. The ink A is recovered to the state as shown in FIG. 4-1 and being prepared for the next air bubble T0 to form and spurt after the large air bubble disappear.

Base on the theory resulted from the aforesaid physical experiment, not only the printing speed is increased more than three times, but more than 15% of the ink is saved.

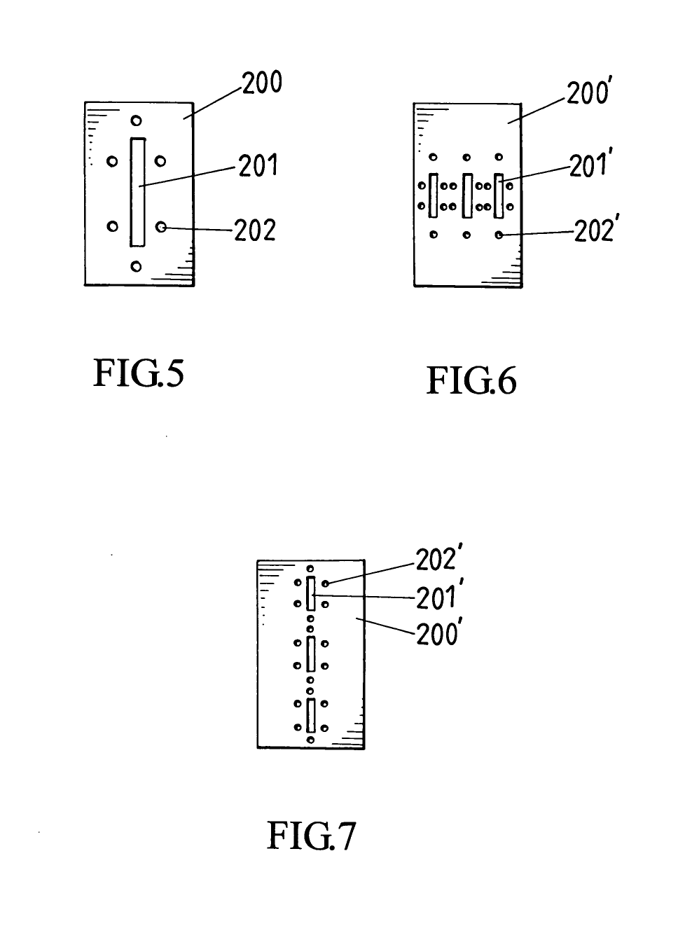

There is a plurality of surrounding breathing nozzle 202 around the main nozzle 201 of the nozzle plate 200 of a black and white printer as shown in FIG. 5. According to FIG. 6 and FIG. 7, a plurality of surrounding breathing nozzle 202 around the main nozzle 201 of three colored nozzle plates 200 are configured in color printer.

To emphasize novelty and practicability, the advantages of the invention are listed below:
1. Power saving—the power supplying time of the main heating resistor 300 is shortened, the air wall formed by the breathing nozzle 202 prevents wasting of the ink A and shortens the distance between the spurting hole and the paper to increase printing speed.
2. Printing quality enhancement-high-speed spurting preventing dissatisfying printing qualities such as scattered ink drops, delayed spurting, or multi-dropped spurting.
3. Enhanced printing speed.
4. Doubled ink resupplying speed.
5. Environmental friendly—the printer is designed that the environmental friendly materials can be used.

In view of the above, the invention do not need to use the principles of hydrodynamics but principles of internal equilibrium for the inkjet nozzles to be more effective, power and cost saving, and improves the quality of printing.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A energy efficient thermal inkjet print head comprising a main nozzle on a nozzle plate, a main heating resistor with curved top; and characteristics that:
at least one breathing nozzle configured around the main nozzle of the nozzle plate; a grouped resistors formed opposite of the breathing nozzle to build an insulating surrounding wall to assist the main heating resistor by forward kinetic energy providing satisfying printing speed and quality.
